(19) United States
(12) Patent Application Publication
(10) Pub. No.: US 2023/0138196 A1
(43) Pub. Date: May 4, 2023

(54) Precision apparatus for placement into storage and/or removal from storage, precision system for placement into storage and/or removal from storage, and method

(71) Applicant: E. Zoller GmbH & Co. KG Einstell- und Messgeraete, Pleidelsheim (DE)

(72) Inventors: Alexander ZOLLER, Pleidelsheim (DE); Christoph WUERTENBERGER, Stuttgart (DE)

(21) Appl. No.: 17/890,031

(22) Filed: Aug. 17, 2022

(30) Foreign Application Priority Data
Aug. 17, 2021 (DE) 10 2021 121 358.4

(51) Int. Cl. B25J 15/04; B23Q 3/155

(52) U.S. Cl. CPC B25J 15/0491; B25J 15/0475; B25J 15/0483; B23Q 3/15553

(57) ABSTRACT

The invention is based on a precision apparatus for placement into storage and/or removal from storage (54) for an at least semiautomated placement into storage and/or removal from storage of tools (10), in particular tool assemblies (12), and/or of tool chucks (14) into and/or out of a storage lift (16), with at least one holding unit (24) for tools (10), in particular tool assemblies (14), and/or tool chucks (14), which is loadable by a handling robot (18) and forms a plurality of storage bins (20, 22).

It is proposed that the holding unit (24) comprises at least one form-fitting centering element (26), which is configured to interact with a centering bolt (28) and/or a centering recess for a submillimeter-precise horizontal orientation of the holding unit (24).

### PRIOR ART

The invention concerns a precision apparatus for placement into storage and/or removal from storage according to the preamble of claim 1, a precision system for placement into storage and/or removal from storage according to claim 13 and a method according to claim 21.

It has already been proposed that tools and tool holders be stored in storage installations having several exchangeable storage levels, like for example Kardex lifts. However, positioning precision when providing the respective levels is often not sufficient to ensure automated loading which is precise, secure and reliable.

The objective of the invention is in particular to provide a generic apparatus having advantageous characteristics with regard to an automated loading of storage lifts. Preferably it is the objective of the invention to improve a precision with regard to providing storage levels of storage lifts. The objective is attained according to the invention by the features of patent claims 1, 13 and 21 while advantageous implementations and further developments of the invention may be gathered from the subclaims.

### ADVANTAGES OF THE INVENTION

The invention is based on a precision apparatus for placement into storage and/or removal from storage, for an at least semiautomated placement into storage and/or removal from storage of tools, in particular tool assemblies, and/or of tool chucks into and/or out of a storage lift, with at least one holding unit for tools, in particular tool assemblies, and/or tool chucks, which is loadable by a handling robot and forms a plurality of storage bins.

It is proposed that the holding unit comprises at least one form-fitting centering element, which is configured to interact with a centering bolt and/or a centering recess for a submillimeter-precise horizontal orientation of the holding unit. This advantageously allows attaining a high degree of precision, in particular of the positioning of the holding unit. Advantageously, in this way precise actuation of a storage lift is enabled. Advantageously safety, reliability and/or accuracy of an automated placement into storage and/or removal from storage of tools, in particular tool assemblies, and/or tool chucks can be improved. By a “storage lift” is in particular a tool storage lift to be understood, comprising at least holding units which can be provided in an exchangeable manner. Preferably the storage lift comprises drawers or drawer-like compartments, via which the holding units are supplied for loading. Preferentially a plurality of holding units are arranged in the storage lift. For a placement into storage and/or removal from storage of tools, in particular tool assemblies, and/or tool chucks, the holding units are taken into a transfer zone of the tool storage lift by means of the tool storage lift. Following the placement into storage and/or removal from storage, the holding units are moved by the tool storage lift into a storage position within the tool storage lift, which is usually not easily accessible from an outside. The storage lift may, for example, be implemented as a storage paternoster lift. The holding units in particular form something like a tool rake comprising a plurality of storage bins. The storage bins of the holding units are preferably arranged side by side (along a main extension direction of the holding units). The holding unit implements at least a portion of a level of the tool storage lift. The holding unit is configured for a placement into storage in a storage region of the storage lift. “Configured” is in particular to mean specifically programmed, designed and/or equipped. By an object being configured for a certain function is in particular to be understood that the object fulfills and/or executes this certain function in at least one application state and/or operation state.

Tools may in particular be embodied as shaft tools, preferably as rotary shaft tools, for example as a drill, as a milling tool, as a profiling tool and/or as a reamer. By tool chucks are in particular components to be understood which are configured for receiving tools and for connecting the tools to machines. In particular, the tool chucks are implemented as tool-machine interfaces. For example, a tool chuck may be embodied as a shrink-clamp chuck, as a hydraulic-expansion chuck, as a compression-clamp chuck, as a collet chuck, or the like. In particular, the holding unit is configured at least for tool chucks in the sizes HSK 40 to HSK 100 and/or for tool chucks of other types, e. g. SK, Coromant Capto®, KM or the like. A “tool assembly” is in particular to mean a combination of a tool and a tool chuck.

A “handling robot” is in particular to mean an industrial robot, preferably an articulated-arm robot, in particular having at least three, preferentially at least four, preferably at least five and particularly preferably at least six robot joints which are movable independently from each other, and/or a handling device and/or a manipulator. The handling robot is in particular configured to manage a material flow from and/or to at least a portion of the storage lift, for example from and/or to the holding units. In particular, the handling robot comprises at least one gripper unit, which is at least configured for gripping a tool and/or a tool chuck. Preferably the handling robot comprises at least one robot-controlling unit. The robot-controlling unit in particular comprises a specifically programmed robot-controlling device which is configured to control, regulate and/or select activities and/or movements of the robot and/or of at least one sub-component of the handling robot. Preferably the robot-controlling unit comprises at least one user interface, in particular for the purpose of influencing a movement at least of a sub-component of the robot and/or of influencing the programming of the robot controlling device.

By a “form-fitting centering element” is in particular an element to be understood which is configured to realize an orientation of the component comprising the form-fitting centering element by creating a form-fit connection with a corresponding element, for example a corresponding element of the handling robot or of a further automated unit that has a centering device and is allocated to a robot module. The centering element may herein be embodied as a, for example bolt-like/bolt-shaped, (form-fitting) projection or as a, for example sheath-shaped, (form-fitting) recess. The centering bolt and/or the centering recess interacting with the form-fitting centering element are arranged separately from the holding unit, preferably separately from the storage lift. “Configured” is in particular to mean specifically programmed, designed and/or equipped. By an object being configured for a certain function is in particular to be understood that the object fulfills and/or executes this certain function in at least one application state and/or operation state. The term “submillimeter-precise” is in particular to mean with an accuracy deviation of less than 1 mm, preferably of less than 0.5 mm, preferentially of less than 0.2 mm and particularly preferentially of maximally 0.05 mm.

It is further proposed that the holding unit comprises at least one further form-fitting centering element, which is configured to interact with a further centering bolt and/or with a further centering recess for a submillimeter-precise horizontal orientation of the holding unit. This advantageously allows further increasing accuracy. It is advantageously possible to avoid an inclined position of the holding unit. Moreover, in the orientation process a force effect on the centering bolt/centering recess is advantageously reducible. In particular, the further form-fitting centering element is arranged and implemented separately from the form-fitting centering element. In particular, the further form-fitting centering element is implemented approximately identically to the form-fitting centering element. Alternatively it is however also conceivable that the further form-fitting centering element is implemented differently from or complementarily to the form-fitting centering element. In particular, in the positioning process a horizontal position of the centering bolt and/or of the centering recess remains at least substantially unchanged. “Substantially unchanged” is in particular to mean a change of the horizontal position of the centering bolt and/or of the centering recess by less than 0.05 mm, preferably less than 0.01 mm.

It is moreover proposed that the form-fitting centering element and the further form-fitting centering element are arranged in end regions of the holding unit, which in particular point away from each other and which, in particular viewed along a main extension direction of the holding unit, are situated opposite each other. In this way advantageously accurate horizontal positioning of the holding unit is enabled. By a “main extension direction” of an object is herein in particular a direction to be understood which runs parallel to a longest edge of a smallest rectangular cuboid just still completely enclosing the object.

It is also proposed that at least a portion of the holding unit which forms the storage bins, is embodied as a lasered and/or riveted bent sheet metal part. This advantageously allows achieving a particularly high degree of precision of the holding unit, in particular of the storage bins of the holding unit. Advantageously a low total weight of the holding unit is achievable. In particular, the holding unit is realized as a compact and/or tension-free component. The tension-free state is advantageously attainable if welding of metal sheets is dispensed with and the production of the holding unit is realized completely by lasering (high laser accuracy) and riveting. In particular, in the holding unit the connection openings for the rivets are also lasered. In this way it is advantageously possible to permanently obtain a precision that is higher in comparison to welded constructions. In addition, it is thus advantageously possible to reduce costs, in particular compared to welded, annealed and burnished variants. In particular, a sheet metal distribution of the holding unit is selected in such a way that there are as few individual parts as possible.

Beyond this it is proposed that at least a portion of the holding unit which comprises the form-fitting centering element, is implemented as a, preferably solid, metal element, which is in particular different from sheet metal. This advantageously allows obtaining a high positioning accuracy, in particular as a deformability of the portion of the holding unit comprising the form-fitting centering element is kept as low as possible. Preferably the metal element is embodied as a solid aluminum block/as a solid aluminum flat material. Of course, alternative materials for the metal element, like for example steel, are also conceivable. The metal element could moreover be substituted by a hard plastic part, for example a hard-plastic block.

If the holding unit forms at least two different kinds of storage bins, high storage flexibility and/or high storage density are/is advantageously achievable. In particular, the different kinds of storage bins are shaped differently. In particular, the different kinds of storage bins are configured for different tool chucks, in particular for different tool assemblies. For example, a first kind of storage bin may be implemented for tool assemblies with short thick tools (e. g. cutter heads) while a second kind of storage bin is configured for tool assemblies with long thin tools (e. g. drills or shaft milling tools). Of course, three or more different kinds of storage pins in one single holding unit are also conceivable.

If then a first kind of storage bin is implemented for a placement into storage and/or removal from storage of tools, in particular tool assemblies, and/or tool chucks from an at least partially vertical placement and/or removal direction, advantageously easy placement/removal of the thick short tools is enabled. If then a second kind of storage bin is implemented for a placement into storage and/or removal from storage of tools, in particular tool assemblies, and/or tool chucks from an (exclusively or almost exclusively) horizontal placement and/or removal direction, advantageously easy placement/removal of the long thin tools is enabled.

In addition, it is proposed that at least one of the storage bins comprises a (rotational) position-fixing element for tool chucks. This advantageously allows achieving a high level of precision of the placement for storage. The (rotational) position-fixing element may be realized, for example, as a projection or as a recess, which is configured to interact/mutually engage with a recess or a projection of the tool chuck.

It is further proposed that the precision apparatus for placement into storage and/or removal from storage comprises a planar base plate carrying the holding unit such that it is horizontally displaceable. This advantageously allows simplifying a positioning process. In particular, at least a portion of the holding unit lies (directly) upon a surface of the base plate. In particular, a friction coefficient between the base plate and the holding unit is selected such that a force generated/generatable by the centering device is sufficient for a displacement of the holding unit (also in a filled state) with respect to the surface of the base plate. In particular, the metal elements with the form-fitting centering elements also lie upon the base plate.

If the holding unit is supported on the base plate in a floating manner, advantageous storage characteristics are achievable, in particular with regard to the horizontal displaceability of the holding unit on the base plate. It is moreover possible to keep costs and production input low. In particular, the metal elements with the form-fitting centering elements are also supported on the base plate in a floating manner.

If the base plate is made of a plastic, in particular of a polyvinyl chloride (PVC), favorable sliding characteristics between the holding unit and the base plate are advantageously achievable. This advantageously allows slightly displacing the holding unit during the centering process. In particular, metal slides better on PVC than on metal.

Furthermore, a precision system for placement into storage and/or removal from storage is proposed, with the storage lift comprising a plurality of precision apparatuses for placement into storage and/or removal from storage which in each case have a holding unit, with the handling robot for loading the storage lift with tools, in particular tool assemblies, and/or with tool chucks, and with at least one centering device comprising an automatedly movable centering bolt and/or an automatedly movable centering recess for a submillimeter-precise horizontal orientation of holding units by generating a form-fit connection of the centering bolt and/or of the centering recess with at least one form-fitting centering element of the holding units. This advantageously allows attaining a high level of precision, in particular when positioning the holding unit. Advantageously, in this way a precise automated actuation of the storage lift for the placement into storage and/or removal from storage of tools, in particular tool assemblies, and/or tool chucks is enabled.

If the centering bolt of the centering device has a conical outer shape and/or the centering recess of the centering device has a conical inner shape, clearance-free centering is advantageously achievable. Advantageously, particularly high positioning precision of the holding unit relative to the handling robot is attainable. In particular, an outer diameter of the conical outer shape of the centering bolt tapers in a direction that points towards the form-fitting centering element. In particular, an inner diameter of the conical inner shape of the centering recess tapers in a direction that points away from the form-fitting centering element. Alternatively, it is also conceivable that the form-fitting centering element has a conical inner or outer shape. In particular, the conical inner shape/the conical outer shape is configured for generating a clearance-free self-centering of the holding unit.

It is also proposed that the centering bolt of the centering device and/or the centering recess of the centering device is automatedly movable along a vertical direction, in particular viewed relative to the surface of the base plate which the holding unit lies upon. This advantageously enables precise (automated) centering of the holding unit relative to the handling robot. In particular, during the centering process the centering bolt of the centering device and/or the centering recess of the centering device are/is moved automatedly, exclusively along the vertical direction.

Moreover, it is proposed that the precision system for placement into storage and/or removal from storage comprises a further centering device with a further centering bolt and/or with a further centering recess, which is configured for a form-fitting interaction with the further form-fitting centering element of the same holding unit (for example for an insertion of a centering bolt into the form-fitting centering element or for putting a centering recess over the form-fitting centering element), said form-fitting interaction being synchronized with the centering bolt of the centering device and/or with the centering recess of the centering device. This advantageously allows achieving a particularly high level of precision of the holding unit, in particular of the entire holding unit. In particular, the centering device is implemented at least substantially identically to the further centering device.

Beyond this it is proposed that the storage lift is configured to optionally provide respectively one of the several precision apparatuses for placement into storage and/or removal from storage/holding units, which are comprised in the storage lift, for an access of the handling robot. In this way advantageously high storage capacity is achievable. In particular, the precision system for placement into storage and/or removal from storage comprises a transfer zone, into which optionally each of the several holding units can be brought by a holding unit supply device of the storage lift, in particular in an automated manner, for a placement into storage and/or removal from storage of tool assemblies or tool chucks.

If the storage lift comprises at least one transfer surface and/or a drawer, which—at least during a placement into storage and/or removal from storage of tools, in particular tool assemblies, and/or of tool chucks into and/or out of the storage lift—carries the holding unit of one of the several precision apparatuses for placement into storage and/or removal from storage comprised in the storage lift, it is advantageously possible to ensure an easy access to the tool assemblies or tool chucks by commercially available handling robots.

If moreover at least the storage lift and the centering device, and preferably the handling robot, are—at least in the transfer zone of the precision system for placement into storage and/or removal from storage—firmly fixed on a common base and/or on a ground (for example tightly screwed, glued, fixedly cemented, welded, etc.), this advantageously enables a particularly high level of precision. In particular, the transfer zone comprises at least the transfer surface and/or the drawer in a (deployed) operation state that is intended for the placement into storage and/or removal from storage.

Furthermore, it is proposed that the precision system for placement into storage and/or removal from storage comprises a holding unit identifying device, which is in particular allocated to the centering device, and which is configured for an identification of individual holding units of the storage lift. This advantageously allows achieving good storage management. In particular, the holding unit identifying device is implemented at least partially integrally with the centering device/mounted to the centering device. This advantageously allows a reduction of complexity. By two units being implemented “partially integrally” is in particular to be understood that the units comprise at least one, in particular at least two, advantageously at least three common elements which are part, in particular a functionally relevant component, of both units. In particular, the holding unit identifying device is embodied as an RFID reading device. However, alternative implementations of the holding unit identifying device, like for example as a barcode reading device, as a 2D barcode reading device, as an NFC reading device, etc., are also conceivable. In particular, each of the holding units of the storage lift comprises a bijective identificatory element, for example an RFID chip, a 2D barcode, a barcode, etc., which is readable by the holding unit identifying device.

Beyond this, a method is proposed for an at least semiautomated precision placement into storage and/or removal from storage of tools, in particular tool assemblies, and/or of tool chucks into and/or out of the storage lift, in particular by means of the precision system for placement into storage and/or removal from storage, with a horizontal detail-positioning step, in which a submillimeter-precise orientation of a holding unit, which was in particular moved out of the storage lift beforehand, relative to a handling robot of the precision system for placement into storage and/or removal from+storage is brought about by generating a form-fit connection of a centering bolt, preferably at least two centering bolts, and/or a centering recess, preferably at least two centering recesses, with a form-fitting centering element, preferably with respectively one form-fitting centering element, of the holding unit that is supported in a horizontally movable manner. This advantageously allows attaining high precision, in particular with regard to the positioning of the holding unit. Advantageously, this enables a precise actuation of a storage lift.

If in the method moreover an unambiguous automated identification of the respective holding unit is made before, during and/or after the positioning step, particularly high-quality, safe and/or failure-proof (automated) storage management is achievable.

The precision apparatus for placement into storage and/or removal from storage according to the invention, the precision system for placement into storage and/or removal from storage according to the invention and the method according to the invention shall herein not be limited to the application and implementation described above. In particular, in order to fulfill a functionality that is described here, the precision apparatus for placement into storage and/or removal from storage according to the invention, the precision system for placement into storage and/or removal from storage according to the invention and the method according to the invention may comprise a number of individual elements, components and units that differs from a number given here.

### DRAWINGS

Further advantages will become apparent from the following description of the drawings. In the drawings an exemplary embodiment of the invention is shown.

The drawings, the description and the claims contain a plurality of features in combination. Someone skilled in the art will purposefully also consider the features separately and will find further expedient combinations.

It is shown in:

FIG. 1 a schematic perspective illustration of a precision system for placement into storage and/or removal from storage for tool assemblies, with a precision apparatus for placement into storage and/or removal from storage comprising a holding unit for the tool assemblies, with a storage lift and with a handling robot,

FIG. 2 a schematic perspective illustration of the holding unit,

FIG. 3 a schematic perspective illustration of a detail of the holding unit,

FIG. 4 a schematic perspective illustration of a transfer zone of the precision system for placement into storage and/or removal from storage with the precision apparatus for placement into storage and/or removal from storage on a deployed transfer surface of the storage lift,

FIG. 5 a schematic perspective illustration of the transfer zone of the precision system for placement into storage and/or removal from storage with a retracted transfer surface of the storage lift, and

FIG. 6 a schematic flow chart of a method for an at last semiautomated placement into storage and/or removal from storage of tool assemblies.

### DESCRIPTION OF THE EXEMPLARY EMBODIMENT

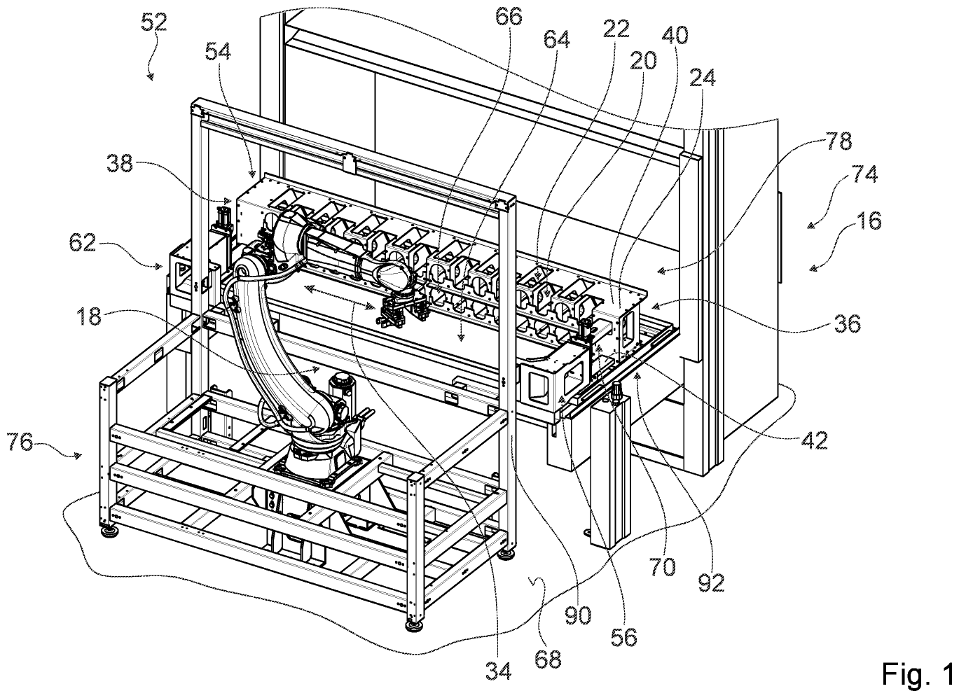

FIG. 1 shows a precision system for placement into storage and/or removal from storage 52. The precision system for placement into storage and/or removal from storage 52 comprises a storage lift 16. The storage lift 16 is realized as a tool-assembly storage lift. The storage lift 16 is configured for the storage of tools 10, tool assemblies 12 and/or tool chucks 14. The precision system for placement into storage and/or removal from storage 52 comprises a handling robot 18. The handling robot 18 is configured for a loading of the storage lift 16 with tools 10, tool assemblies 12 and/or tool chucks 14. The precision system for placement into storage and/or removal from storage 52 comprises a storage module 74. The storage lift 16 is allocated to the storage module 74 of the precision system for placement into storage and/or removal from storage 52. The precision system for placement into storage and/or removal from storage 52 comprises a robot module 76. The handling robot 18 is allocated to the robot module 76. The storage module 74 and the robot module 76 form sub-units of the precision system for placement into storage and/or removal from storage 52, which are completely separate and/or separable from each other.

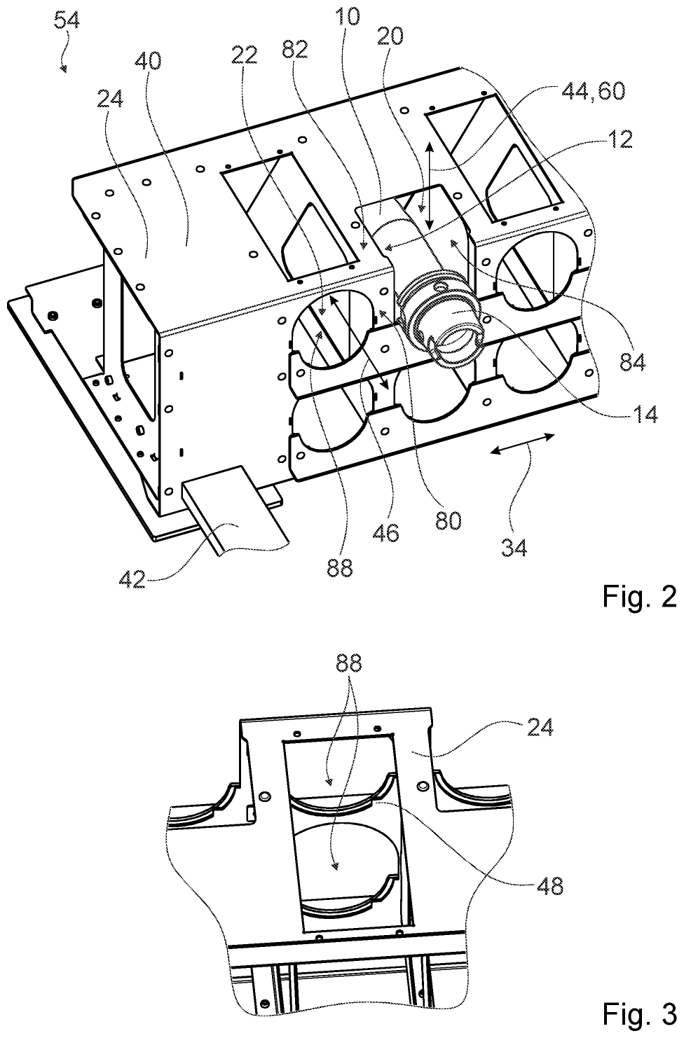

The precision system for placement into storage and/or removal from storage 52 comprises a plurality of precision apparatuses for placement into storage and/or removal from storage 54. The storage lift 16 comprises a plurality of (e. g. ten or more) holding units 24. The precision apparatuses for placement into storage and/or removal from storage 54 are configured for a placement into storage and/or removal from storage of tools 10, tool assemblies 12 and/or tool chucks 14 into and/or out of the storage lift 16. Each precision apparatus for placement into storage and/or removal from storage 54 comprises a holding unit 24. The holding unit 24 is configured for holding and/or receiving the tools 10, tool assemblies 12 and/or tool chucks 14. The holding unit 24 forms a tool rake for receiving and holding the tools 10, tool assemblies 12 and/or tool chucks 14. The holding unit 24 comprises a plurality of storage bins 20, 22 (cf. also FIG. 2). The storage bins 20, 22 can be loaded by the handling robot 18. A part 40 of the holding unit 24 that forms the storage bins 20, 22 is embodied as a lasered and/or riveted bent sheet-metal part. The part 40 of the holding unit 24 that forms the storage bins 20, 22, preferably the entire holding unit 24, is produced free of weldings (welding seams) or the like.

The holding units 24 in each case form two different kinds of storage bins 20, 22. A first kind of storage bin 20 of the holding unit 24 is implemented for a placement into storage and/or removal from storage of tool assemblies 12 from an at least partially vertical placement and/or removal direction 44. The storage bins 20 of this type have a continuous receiving opening 84 extending over a portion of a front side 80 of the holding unit 24 and at the same time over a portion of an upper side 82 of the holding unit 24. On the upper side 82 the receiving opening 84 is larger than a maximal diameter of the tool chuck 14 of the tool assembly 12 for which the storage bin 20 is provided. This advantageously allows introducing a tool assembly 12 into the holding unit 24, whose tool 10 has a larger maximal diameter than the tool chuck 14 of the tool assembly 12. A second kind of storage bin 22 of the holding unit 24 is implemented fora placement into storage and/or removal from storage from an approximately purely horizontal placement and/or removal direction 46. The storage bins 22 of this type have a receiving opening 88 which is arranged entirely on the front side 80 of the holding unit 24. The holding unit 24 moreover has further recesses which are not configured for a placement into storage and/or removal from storage of tools 10, tool assemblies 12 and/or tool chucks 14 but are intended to serve for a reduction of the total weight of the holding unit 24. Each storage bin 20, 22 further comprises a (rotational) position-fixing element 48 for tool chucks 14 (cf. FIG. 3). In the case illustrated in FIG. 3, the one (rotational) position-fixing element 48 is realized as a projection that is configured to mutually engage with a complementary element (not shown) of the tool chuck 14, thus defining/fixing a rotational position of the tool chuck 14 in the storage bin 20, 22. An opening shape and/or opening size of the receiving openings 84, 88, in particular in a region of the front side 80 of the holding unit 24, is adapted to tool chucks 14 of tool assemblies 12, which are to be placed into storage respectively. In the case illustrated in the figures, the receiving openings 84, 88 are implemented for receiving tool assemblies 12 with HSK-100 tool chucks 14. The holding unit 24 that is shown by way of an example in FIG. 2 has two levels. In a lower level only storage bins 22 of the second kind are comprised whereas an upper level comprises storage bins 20 of the first kind and storage bins 22 of the second kind.

The storage lift 16 comprises a storage space 78. The storage space 78 is configured at least for receiving holding units 24. The holding unit 24 can be brought into the storage space 78 by the storage lift 16. The storage space 78 of the storage lift 16 comprises several levels (not shown), which are in each case configured for receiving a holding unit 24 or several holding units 24.

The storage lift 16 is configured to optionally provide respectively one of the several precision apparatuses for placement into storage and/or removal from storage 54/holding units 24, which are comprised in the storage lift 16, for an access by the handling robot 18. The precision system for placement into storage and/or removal from storage 52 forms a transfer zone 66. The storage lift 16 comprises at least one transfer surface 64 and/or a drawer. The transfer surface 64 is arranged in the transfer zone 66 of the precision system for placement into storage and/or removal from storage 52. In the case of an implementation as a drawer, the drawer can be brought into the transfer zone 66 of the precision system for placement into storage and/or removal from storage 52 by deployment. The transfer surface 64 or the drawer carries one of the holding units 24 comprised in the storage lift 16, at least during a placement into storage and/or removal from storage of tools 10, tool assemblies 12 and/or tool chucks 14 into and/or out of the storage lift 16. The storage lift 16 comprises a rail system 92, along which the transfer surface 64 can be deployed and retracted like a drawer.

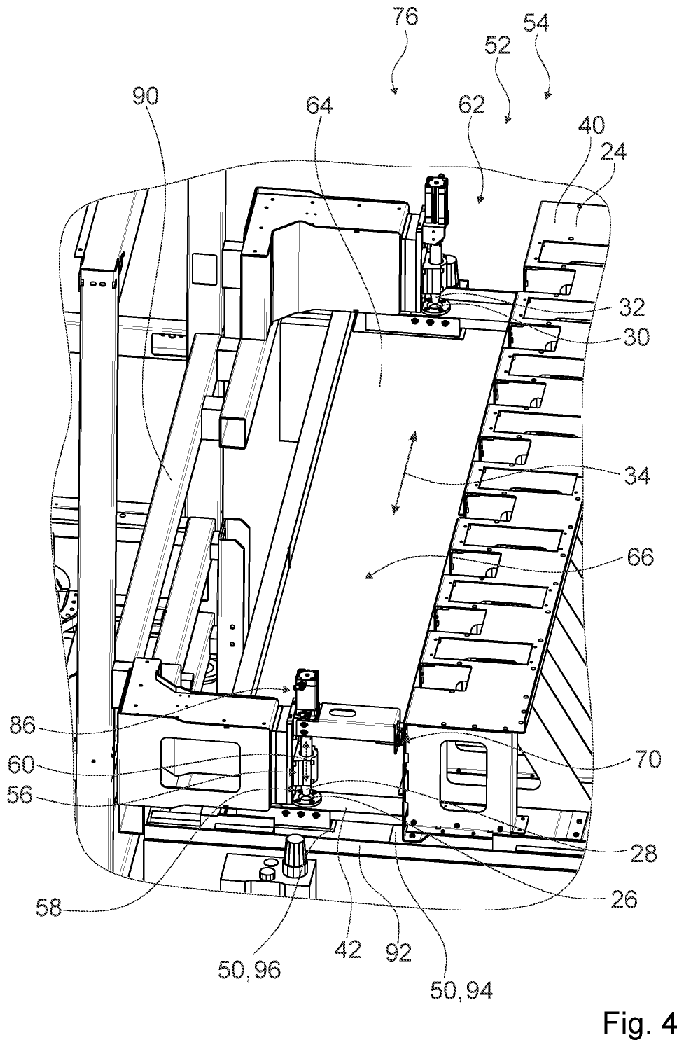

The precision system for placement into storage and/or removal from storage 52 comprises a centering device 56 (cf. also FIG. 4). The centering device 56 is configured for a submillimeter-precise horizontal orientation of the holding units 24 relative to the handling robot 18. The centering device 56 is allocated to the robot module 76. The centering device 56 comprises a centering bolt 28. Alternatively, the centering device 56 could have a centering recess (not shown). The centering bolt 28 is automatedly movable. The centering bolt 28 is automatedly movable along a vertical direction 60. The centering device 56 comprises a drive unit 86, which is configured for a hydraulic or pneumatic generation of the movement of the centering bolt 28 along the vertical direction 60. The centering device 56 is mounted to a frame unit 90 of the robot module 76. The frame unit 90 surrounds the handling robot 18 at least partially. The centering bolt 28 of the centering device 56 has a conical outer shape 58. Alternatively, in the case of an implementation as a centering recess, a conical inner shape is conceivable. The centering device 56 is realized separately from the handling robot 18. The centering device 56 is realized separately from the storage lift 16. The holding units 24 each have a form-fitting centering element 26. The form-fitting centering element 26 is implemented complementarily to the centering element (centering bolt 28/centering recess) of the centering device 56. The form-fitting centering element 26 has a conical inner shape (in the case of a sheath-like implementation) or a conical outer shape 58 (in the case of a bolt-shaped implementation). By its conical shape (adapted to the shape of the centering bolt 28 or of the centering recess) the form-fitting centering element 26 enables tolerance-free self-centering of the holding unit 24 relative to the robot module 76. The centering bolt 28 is configured to bring about the submillimeter-precise horizontal orientation of the holding unit 24 by generating a form-fit connection with the form-fitting centering element 26. As a result of the vertical introduction of the centering bolt 28 into the form-fitting centering element 26 that is realized as a recess, the holding unit 24 having the form-fitting centering element 26 is displaced horizontally until the centering bolt 28 fits accurately into the form-fitting centering element 26. Herein the centering bolt 28 remains unmoved horizontally. A portion 42 of the holding unit 24 that comprises the form-fitting centering element 26 is implemented as a solid metal element that is different from a sheet metal. The portion 42 of the holding unit 24 that comprises the form-fitting centering element 26 is thus not part of the lasered and riveted bent sheet metal part. The portion 42 of the holding unit 24 that comprises the form-fitting centering element 26 is connected with the bent sheet metal part. The portion 42 of the holding unit 24 that comprises the form-fitting centering element 26 is mounted in an opening of the bent sheet metal part and is fixed therein. The portion 42 of the holding unit 24 that comprises the form-fitting centering element 26 protrudes on the front side 80 beyond the portion 40 of the holding unit 24 that is realized as a bent sheet metal part. The portion 42 of the holding unit 24 that comprises the form-fitting centering element 26 protrudes beyond the portion 40 of the holding unit 24 that is realized as a bent sheet metal part, toward the robot module 76 and/or the centering device 56.

The holding unit 24 comprises a further form-fitting centering element 30. The further form-fitting centering element 30 is also configured for a horizontal orientation of the holding unit 24 via an interaction with a further centering bolt 32 (alternatively: centering recess). The submillimeter-precise orientation of the entire holding unit 24 is in particular achievable by the combination of the two form-fitting centering elements 26, 30. The form-fitting centering element 26 and the further form-fitting centering element 30 are arranged in end regions 36, 38 of the holding unit 24 which, viewed along a main extension direction 34 of the holding unit, are situated opposite each other, pointing away from each other. The further form-fitting centering element 30 is arranged in a further solid metal element that is different from the bent sheet metal part. The precision system for placement into storage and/or removal from storage 52 comprises a further centering device 62 with the further centering bolt (32 (alternatively: with a further centering recess). The further centering bolt 32 of the further centering device 62 is configured for a form-fitting interaction with the further form-fitting centering element 30 of the same holding unit 24, the form-fitting interaction being synchronized with the centering bolt 28 of the centering device 56.

The precision apparatus for placement into storage and/or removal from storage 54 comprises a planar base plate 50. The base plate 50 carries the holding unit 24, which is respectively provided by the storage lift 16 for a placement into storage and/or removal from storage, such that the holding unit 24 is horizontally displaceable. The holding units 24 are supported on a surface of the base plate 50 so as to be horizontally displaceable. The base plate 50 is arranged in the transfer zone 66. The base plate 50 is laid upon the transfer surface 64 or the drawer, and is preferably fixed on the transfer surface 64 or the drawer. It is conceivable that the base plate 50 is divided into several individual sub-plates 94, 96, which respectively form a contact surface for portions of the holding unit 24 to lie thereon. The holding unit 24 is supported in a floating manner on the base plate 50 or on the several sub-plates 94, 96 which together form the base plate 50. The base plate 50 is made of a plastic. The base plate 50 is made of a polyvinyl chloride. In the case shown exemplarily in FIG. 4, the holding unit 24 lies upon a first sub-plate 94 of the base plate 50, whereas the metal elements of the holding unit 24 lie upon a second sub-plate 96 of the base plate 50, which is realized separately from the first sub-plate 94 of the base plate 50.

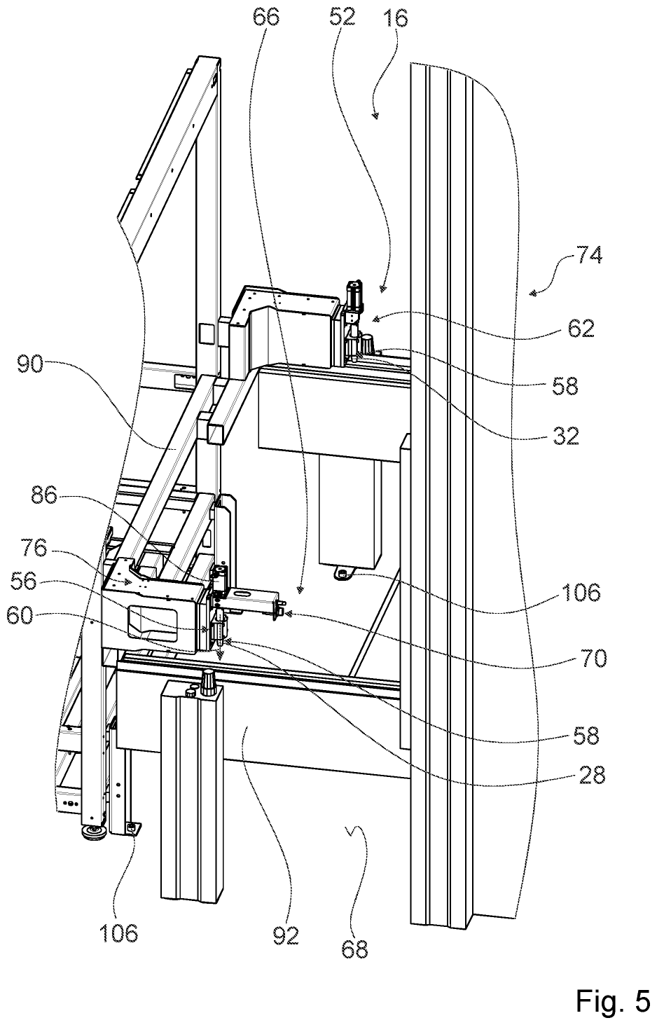

FIG. 5 shows a schematic perspective view of the transfer zone 66 of the precision system for placement into storage and/or removal from storage 52, with the transfer surface 64, which is embodied as a drawer, being presently retracted into the storage space 78 of the storage lift 16. The storage lift 16 and the centering device(s) 56, 62 is/are—at least in the transfer zone 66, at least indirectly — fixed firmly to the ground 68. The storage lift 16 and the handling robot 18 are fixed firmly to the ground 68, at least in the transfer zone 66. The storage module 74 and the robot module 76 are fixed firmly to the ground 68, at least in the transfer zone 66. The storage module 74 and the robot module 76 are firmly screwed with the ground 68 via ground anchorings 106, at least in the transfer zone 66. In the case illustrated in FIG. 5, the storage module 74 and the robot module 76 are tightly screwed to the ground 68. Alternatively, a fixing of storage lift 16, centering device(s) 56, 62 and handling robot 18 and/or of storage module 74 and robot module 76 to a common, preferably comparably heavy, basis element, like for example a concrete block or a thick steel plate, is also conceivable.

The precision system for placement into storage and/or removal from storage 52 comprises a holding unit identifying device 70. The holding unit identifying device 70 is allocated to one of the centering devices 56, 62. The precision system for placement into storage and/or removal from storage 52 comprises identificatory elements (not shown), which are in each case allocated to one of the holding units 24. The identificatory elements are respectively fastened on or in the holding units 24. The holding unit identifying device 70 is configured for an identification of the individual holding units 24 of the storage lift 16. The holding unit identifying device 70 is configured for an identification of the individual holding units 24 of the storage lift 16 during the placement into storage and/or during the removal from storage.

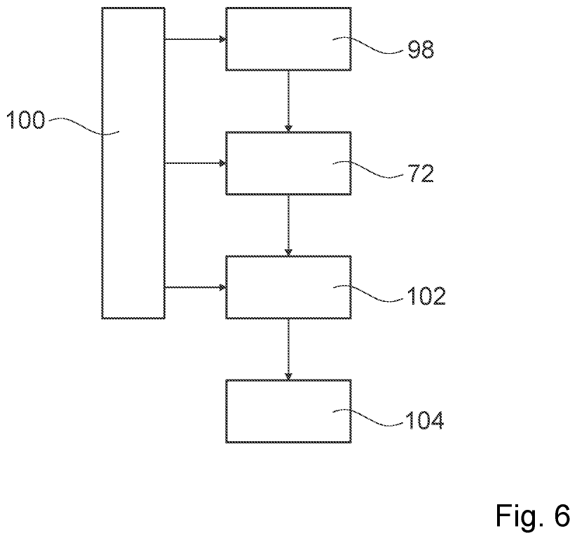

FIG. 6 shows a schematic flow chart of a method for at least semiautomated placement into storage and/or removal from storage of tools 10, tool assemblies 12 and/or tool chucks 14 into and/or out of the storage lift 16 using the precision system for placement into storage and/or removal from storage 52. In at least one first method step 98, a holding unit 24 is brought into the transfer zone 66 by the storage lift 16. Herein the holding unit 24 is positioned on the base plate 50 that lies on the transfer surface 64 and is deployed by a drawer-like function out of the storage space 78 of the storage lift 16. In at least one directly following horizontal detail-positioning step 72, a submillimeter-precise orientation of the holding unit 24, which was moved out of the storage lift 16 beforehand, is realized relative to the handling robot 18 of the precision system for placement into storage and/or removal from storage 52. For this purpose, in the detail-positioning step 72 a horizontal displacement of the holding unit 24 relative to the handling robot 18 is brought about by generating a form-fit connection of the centering bolt 28, of the two centering bolts 28, 32 (or alternatively: one or several centering recess/es) with the form-fitting centering element 26, preferably with a respective one of the form-fitting centering elements 26, 30. By an insertion of the conically shaped centering bolts 28, 32 into the form-fitting centering elements 26, 30 from above, the holding unit 24 is automatically pulled/pushed into the desired position. The relative position(s) of the handling robot 18 and the centering device(s) 56, 62, in particular the centering bolts 28, 32, are/is fix and are/is preferably known to a robot control of the handling robot 18. In a further method step 100 taking place before, during and/or after the detail-positioning step 72, an unambiguous automated identification of the respective holding unit 24 is carried out by the holding unit identifying device 70. As a result, the storage position of the presently stored tool assembly 12 in the storage lift 16 or the positions, numbers, etc. of free spaces in the storage lift 16 can be registered in a computer system, e. g. a computer system of the storage lift 16, of the robot module 76 or of another part of an industrial installation. In at least one further method step 102 a tool assembly 12 is placed into storage in one of the storage bins 20, 22 of the available holding unit 24 or is removed from storage out of one of the storage bins 20, 22 of the available holding unit 24 by the handling robot 18. In at least one further method step 104 the holding unit 24 is returned into the storage space 78 and, if applicable, a further holding unit (not shown) is brought into the transfer zone 66.

### REFERENCE NUMERALS

10 tool
12 tool assembly
14 tool chuck
16 storage lift
18 handling robot
20 storage bin
22 storage bin
24 holding unit
26 form-fitting centering element
28 centering bolt
30 further form-fitting centering element
32 further centering bolt
34 main extension direction
36 end region
38 end region
40 portion
42 portion
44 vertical placement and/or removal direction
46 horizontal placement and/or removal direction
48 (rotational) position-fixing element
50 base plate
52 precision system for placement into storage and/or removal from storage
54 precision apparatus for placement into storage and/or removal from storage
56 centering device
58 conical outer shape
60 vertical direction
62 further centering device
64 transfer surface
66 transfer zone
68 ground
70 holding unit identifying device
72 detail-positioning step
74 storage module
76 robot module
78 storage space
80 front side
82 upper side
84 receiving opening
86 drive unit
88 receiving opening
90 frame unit
92 rail system
94 sub-plate
96 sub-plate
98 method step
100 method step
102 method step
104 method step
106 ground anchoring

1. A precision apparatus for placement into storage and/or removal from storage for an at least semiautomated placement into storage and/or removal from storage of tools, in particular tool assemblies, and/or of tool chucks into and/or out of a storage lift, with at least one holding unit for tools, in particular tool assemblies, and/or tool chucks, which is loadable by a handling robot and forms a plurality of storage bins, wherein the holding unit comprises at least one form-fitting centering element, which is configured to interact with a centering bolt and/or a centering recess for a submillimeter-precise horizontal orientation of the holding unit.

2. The precision apparatus for placement into storage and/or removal from storage according to claim 1, wherein the holding unit comprises at least one further form-fitting centering element, which is configured to interact with a further centering bolt and/or with a further centering recess for a submillimeter-precise horizontal orientation of the holding unit.

3. The precision apparatus for placement into storage and/or removal from storage according to claim 2, wherein the form-fitting centering element and the further form-fitting centering element are arranged in end regions of the holding unit which, in particular viewed along a main extension direction of the holding unit, are situated opposite each other.

4. The precision apparatus for placement into storage and/or removal from storage according to claim 1, wherein at least a portion of the holding unit which forms the storage bins is embodied as a lasered and/or riveted bent sheet metal part.

5. The precision apparatus for placement into storage and/or removal from storage according to claim 1, wherein at least a portion of the holding unit which comprises the form-fitting centering element is implemented as a, preferably solid, metal element, which is in particular different from a sheet metal.

6. The precision apparatus for placement into storage and/or removal from storage according to claim 1, wherein the holding unit forms at least two different kinds of storage bins.

7. The precision apparatus for placement into storage and/or removal from storage according to claim 6, wherein a first kind of storage bin is implemented for a placement into storage and/or removal from storage of tools, in particular tool assemblies, and/or of tool chucks from an at least partially vertical placement and/or removal direction.

8. The precision apparatus for placement into storage and/or removal from storage according to claim 7, wherein a second kind of storage bin is implemented for a placement into storage and/or removal from storage of tools, in particular tool assemblies, and/or tool chucks from a horizontal placement and/or removal direction.

9. The precision apparatus for placement into storage and/or removal from storage according to claim 1, wherein at least one of the storage bins comprises a (rotational) position-fixing element for tool chucks.

10. The precision apparatus for placement into storage and/or removal from storage according to claim 1, comprising a planar base plate carrying the holding unit such that it is horizontally displaceable.

11. The precision apparatus for placement into storage and/or removal from storage according to claim 10, wherein the holding unit is supported on the base plate in a floating manner.

12. The precision apparatus for placement into storage and/or removal from storage according to claim 10, wherein the base plate is made of a plastic, in particular of a polyvinyl chloride (PVC).

13. A precision system for placement into storage and/or removal from storage, with a storage lift comprising a plurality of precision apparatuses for placement into storage and/or removal from storage according to claim 1 which in each case have a holding unit, with a handling robot for loading the storage lift with tools, in particular tool assemblies, and/or tool chucks, and with at least one centering device comprising an automatedly movable centering bolt and/or an automatedly movable centering recess for a submillimeter-precise horizontal orientation of holding units by generating a form-fit connection of the centering bolt and/or the centering recess with at least one form-fitting centering element of the holding units.

14. The precision system for placement into storage and/or removal from storage according to claim 13, wherein the centering bolt of the centering device has a conical outer shape and/or the centering recess of the centering device has a conical inner shape.

15. The precision system for placement into storage and/or removal from storage according to claim 13, wherein the centering bolt of the centering device and/or the centering recess of the centering device is automatedly movable along a vertical direction.

16. The precision system for placement into storage and/or removal from storage according to claim 13, comprising a further centering device with a further centering bolt and/or with a further centering recess, which is configured for a form-fitting interaction with a further form-fitting centering element of the same holding unit, said form-fitting interaction being synchronized with the centering bolt of the centering device and/or with the centering recess of the centering device.

17. The precision system for placement into storage and/or removal from storage according to claim 13, wherein the storage lift is configured to optionally provide respectively one of the several precision apparatuses for placement into storage and/or removal from storage/holding units comprised in the storage lift for an access of the handling robot.

18. The precision system for placement into storage and/or removal from storage according to claim 13, wherein the storage lift comprises at least one transfer surface and/or a drawer, which—at least during a placement into storage and/or removal from storage of tools, in particular tool assemblies, or of tool chucks into and/or out of the storage lift—carries the holding unit of one of the several precision apparatuses for placement into storage and/or removal from storage comprised in the storage lift.

19. The precision system for placement into storage and/or removal from storage according to claim 13, wherein at least the storage lift and the centering device, and preferably the handling robot, are—at least in a transfer zone of the precision system for placement into storage and/or removal from storage—firmly fixed on a common base and/or on a ground.

20. The precision system for placement into storage and/or removal from storage according to claim 13, comprising a holding unit identifying device, which is in particular allocated to the centering device, and which is configured for an identification of individual holding units of the storage lift.

21. A method for an at least semiautomated precision placement into storage and/or removal from storage of tools, in particular tool assemblies, and/or of tool chucks into and/or out of a storage lift, in particular by means of a precision system for placement into storage and/or removal from storage according to claim 13.

22. The method according to claim 21, comprising a horizontal detail-positioning step, in which a submillimeter-precise orientation of a holding unit, which was in particular moved out of the storage lift beforehand, relative to a handling robot of the precision system for placement into storage and/or removal from storage is brought about by generating a form-fit connection of a centering bolt, preferably at least two centering bolts, and/or of a centering recess, preferably at least two centering recesses, with a form-fitting centering element, preferably with respectively one form-fitting centering element, of the holding unit that is supported in a horizontally movable manner.

23. The method according to claim 22, wherein an unambiguous automated identification of the respective holding unit is made before, during and/or after the detail-positioning step.
